(19) United States
(12) Patent Application Publication
(10) Pub. No.: US 2008/0086419 A1
(43) Pub. Date: Apr. 10, 2008

(54) BACK OFFICE CONVERSION

(75) Inventors: Tami Barron, League City, TX (US); Bruce Dragt, Highlands Ranch, CO (US); Kerry Sellen, Kemah, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/863,573

(22) Filed: Sep. 28, 2007

Related U.S. Application Data
(60) Provisional application No. 60/828,727, filed on Oct. 9, 2006.

(51) Int. Cl. G06Q 40/00; G06F 17/00; G06F 17/40

(52) U.S. Cl. 705/44; 705/45

(57) ABSTRACT

Embodiments of the invention provide methods and systems for handling a check submitted in a transaction. According to one embodiment, a method for handling a check submitted in a transaction can comprise requesting authorization of the transaction from a check processing device based on information from the check and other possible information. For example, authorizing the transaction can comprise requesting authorization of the transaction by an authorization service from the check processing device. In response to the authorization service authorizing the transaction, a notification of the transaction can be received from the check processing device. Image data representing an image of the check can also be received. A reconciliation process can be performed based on the notification and the image data.

### CROSS-REFERENCES TO RELATED APPLICATIONS

This application claims the benefit of U.S. Provisional Application No. 60/828,727, filed Oct. 9, 2006, entitled BACK OFFICE CONVERSION, the complete disclosure of which is incorporated herein by reference in its entirety for all purposes.

### BACKGROUND OF THE INVENTION

With the onset of electronic check conversion there are now a number of options as to how checks can be processed for settlement. For example, one could still use the physical check for submission to the check writer's financial institution. One could utilize what is commonly referred to as electronic check processing which is also known as point of purchase processing. In the case of electronic check processing if there is existing information available to a merchant about a consumer, then there is no need to image the check. Rather the consumer can be handed back the check and in some instances sign a receipt at the point of sale. Another option is back office conversion which will be implemented beginning in March of 2007. Under the new rules passed by the National Automated Clearinghouse Association (NACHA) a business is required to keep a copy of a check for archival and retrieval purposes. This image can be used for pure settlement purposes as a record of the transaction or for information only. Still another option is Check 21 processing. Under Check 21 legislation, an image of the front and back side of a check is required to process the transaction. The two-sided image is submitted for electronic processing in place of the typical check instrument.

Therefore, there are several different options for processing checks. It is likely that there will be further alternatives in the future. The imaging of checks can take place at different locations. For example, electronic check processing through point of purchase could involve imaging a check, or parts of the check, at the point of sale device since the check is handed back to the consumer once it is presented and authorized at the point of sale device. In contrast, back office conversion of checks requires the check to be copied prior to destruction. Only the front of the check needs to be imaged under back office conversion rules. Finally, under Check 21 procedures a two-sided image is required for processing a check under that system. Thus, a variety of imaging options are available depending upon which processing system will be utilized to process the check. Thus, there is a need for methods and systems or handling checks that can help to integrate these different imaging and processing options.

### BRIEF SUMMARY OF THE INVENTION

Embodiments of the invention provide methods and systems for handling a check submitted in a transaction. According to one embodiment, a method for handling a check submitted in a transaction can comprise authorizing the transaction based on information from the check. For example, authorizing the transaction can comprise requesting authorization of the transaction by an authorization service from a check processing device. Authorization may also be based on other information collected at or by the check processing device. For example, such information can include but is not limited to a driver's license number, a phone number, or other identifying information for a party presenting the check. In response to authorizing the transaction, a notification of the transaction can be received from the check processing device. Image data representing an image of the check can also be received. A reconciliation process can be performed based on the notification and the image data.

In some cases, a single settlement process can be performed. In such cases, the single settlement process can comprise aggregating data of a plurality of checks. The plurality of checks can comprise checks to be settled via an Automated Clearinghouse (ACH) process and checks to be settled via a Check 21 process. The aggregated data can be submitted to an authorization service for settlement and a single settlement for the plurality of checks can be received from the authorization service.

In other cases, a split settlement process can be performed. In such cases, the split settlement process can comprise determining whether the check can be submitted for settlement via an Automated Clearinghouse (ACH) process. In response to determining the check can be submitted for settlement via the ACH process, the check data can be submitted to an authorization service to in turn be submitted by the authorization service for settlement via an ACH network. In response to determining the check cannot be submitted for settlement via an ACH process, data of a plurality of checks can be aggregated and submitted to an authorization service for settlement via a Check 21 process. A single settlement for the plurality of checks can be received from the authorization service.

According to another embodiment, a system for handling a check submitted in a transaction can comprise a check processing device. The check processing device can be adapted to receive information from the check, request authorization the transaction based on information from the check and possibly other information, and, in response to receiving an indication of authorization of the transaction, provide a notification of the transaction. For example, the check processing device can be adapted to request authorization of the transaction from an authorization service. The system can also include a merchant system communicatively coupled with the check processing device. The merchant system can be adapted to receive the notification of the transaction from the check processing device, receive image data representing an image of the check, and perform a reconciliation process based on the notification and the image data.

In some cases, the merchant system can be adapted to perform a single settlement process. In such cases, the single settlement process can comprise aggregating data of a plurality of checks. The plurality of checks can comprise checks to be settled via an Automated Clearinghouse (ACH) process and checks to be settled via a Check 21 process. The aggregated data can be submitted to an authorization service for settlement and a single settlement for the plurality of checks can be received from the authorization service.

In other cases, the system can be adapted to perform a split settlement process. In such cases, the authorization service can be adapted to determine whether the check can be submitted for settlement via an Automated Clearinghouse (ACH) process. In response to determining the check can be submitted for settlement via the ACH process, the authorization service can submit the check data for settlement via an ACH network. In response to a determination be the authorization service that the check cannot be submitted for settlement via an ACH process, the merchant system can aggregate data of a plurality of checks, submit the aggregated data to the authorization service for settlement via a Check 21 process, and receive from the authorization service a single settlement for the plurality of checks.

According to yet another embodiment, a machine-readable medium can have stored thereon a series of instructions which, when executed by a processor, cause the processor to handle a check submitted in a transaction by requesting authorization of the transaction from a check processing device based on information from the check. For example, the check processing device can request authorization of the transaction by an authorization service. Authorization may also be based on other information collected at or by the check processing device. For example, such information can include but is not limited to a driver's license number, a phone number, or other identifying information for a party presenting the check. In response to authorizing the transaction, a notification of the transaction can be received from the check processing device. Image data representing an image of the check can also be received. A reconciliation process can be performed based on the notification and the image data.

In some cases, a single settlement process can be performed. In such cases, the single settlement process can comprise aggregating data of a plurality of checks. The plurality of checks can comprise checks to be settled via an Automated Clearinghouse (ACH) process and checks to be settled via a Check 21 process. The aggregated data can be submitted to an authorization service for settlement and a single settlement for the plurality of checks can be received from the authorization service.

In other cases, a split settlement process can be performed. In such cases, the split settlement process can comprise determining whether the check can be submitted for settlement via an Automated Clearinghouse (ACH) process. In response to determining the check can be submitted for settlement via the ACH process, the check data can be submitted to the authorization service for settlement via an ACH network. In response to determining the check cannot be submitted for settlement via an ACH process, data of a plurality of checks can be aggregated and submitted to the authorization service for settlement via a Check 21 process. A single settlement for the plurality of checks can be received from the authorization service.

### BRIEF DESCRIPTION OF THE DRAWINGS

FIG. 1 is a block diagram illustrating an exemplary environment in which embodiments of the present invention may be implemented.

FIG. 2 is a block diagram illustrating an exemplary computer system upon which embodiments of the present invention may be implemented.

FIG. 3 illustrates an authorization and settlement process according to one embodiment of the present invention.

FIG. 4 illustrates a returns management process according to one embodiment of the present invention.

FIG. 5 illustrates a single settlement process according to one embodiment of the present invention.

FIG. 6 illustrates a split settlement process according to one embodiment of the present invention.

FIG. 7 is a flowchart illustrating a process for handling a check submitted in a transaction according to one embodiment of the present invention.

FIG. 8 is a flowchart illustrating a process for single settlement according to one embodiment of the present invention.

FIG. 9 is a flowchart illustrating a process for split settlement according to one embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the invention provide methods and systems for processing various financial transactions initiated by or otherwise involving use of a check as a form of payment. In some such embodiments, the processes are executed by an entity on behalf of one or more client organizations. The description below sometimes provides illustrations that use an example where a client organization is a financial institution, but there is no such requirement for the invention and the methods are intended also to be applicable to other types of organizations that make use of large collections of data. For example, embodiments of the invention may also be used for managing health-care documents or information.

The description herein sometimes refers to “clients” and to “customers.” Reference to “clients” is intended to refer to persons, i.e. individuals, entities, or their agents, on whose behalf a set of information is managed. Reference to “customers” or “consumer” is intended to refer to persons, i.e. individuals, entities, or their agents, who are the subject of or related to that information. Thus, merely for purposes of illustration, in the case where the information comprises credit-card account records for a credit card issued to Mr. Jones by Bank A, Bank A corresponds to a client and Mr. Jones corresponds to a customer or consumer.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to, portable or fixed storage devices, optical storage devices, wireless channels, and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. One or more processors may perform the necessary tasks.

Generally speaking, embodiments of the present invention provide methods and systems to support back office conversions of paper checks received at a point-of-sale. For example, at the end of the day, or at several times throughout the day, a merchant closes their register and takes the paper checks to the back office. The checks may be submitted through a terminal that scans the Magnetic ink Character Recognition (MICR) information of the check and images the front and back of the check. In other cases, the point-of-sale device may be adapted to scan or otherwise image the check upon receipt and supply the image data to the back office merchant system. The merchant may then either: (1) utilize a software package that reconciles, allows for item correction, and performs file creation/submission; (2) outsource the back office function; or (3) use a combination of the two. Files can be submitted either directly to the merchant's bank or to the merchant's check processing service.

According to one embodiment, a point-of-sale authorization may be added to the back office conversion check processing service. That is, a merchant can submit a live authorization request to a check processing service or other authorization service and receive instructions back from the service. The intent of the authorization can encompass several purposes including but not limited to: (1) risk/fraud management; (2) ACH eligibility; (3) Settlement eligibility; (4) capture of information; and/or (5) image capture instructions. With the addition of risk/fraud management, an approval or decline response can be given based on the risk of the transaction and the type of merchant. The addition can also allow the merchant to receive warranty protection for their returned checks. The authorization may be to determine whether or not an item is eligible to be converted to an ACH item. ACH eligibility can be based on several criteria including but not limited to: (1) ACH rules; (2) Routing number validity; (3) Account Number Validity; (4) Settlement history on that MICR; and/or (5) merchant parameters. Broader defined settlement eligibility could be determined by a rules-based system that determines a settlement path based on parameters established globally or at the merchant level—example: an ACH item can be settled by an ACH process while other items can be tagged for image settlement. In another example, a scoring methodology or by merchant instructions can be used (an example is where a consumer opts out of ACH conversion, the merchant can notify the authorization system and the item can be “tagged” as non-ACH-eligible). The authorization system can be used as the front end capture of transaction information. A merchant may use this in order to provide a reconciliation tool between the front end capture of transaction information and the back end capture of information. It can also be used to determine image capture requirements at the point of sale i.e. if an item is ACH ineligible, capture an image of both the front and back of the check for the purposes of image settlement. Or if an item is higher risk, you may want to capture the front and back in case an Image Replacement Document (IRD) needs to be created in the future. The authorization process may be used for any combination of the above.

According to one embodiment, a merchant may choose to convert their checks either at the point-of-sale or in the back office, or both. With the addition of the front end authorization, a merchant may choose “split settlement processing”. Under split settlement, items approved at the point-of-sale as eligible for ACH can be processed through the ACH Network from the point-of-sale capture data. Items not approved as ACH eligible can wait to be processed as image exchange items when the image is received from the merchants hardware/software package. In this model, the ACH items may settle to the merchants account prior to the image items processed at the point-of-sale on the same day as the ACH items. It should be understood that, while discussed herein with reference to an ACH settlement process and a Check 21 settlement process, additional and/or different settlement processes may be used. For example, other settlement processes may handle checks as a remotely created check, a photo-in-lieu of a check, or in another manner as known in the art. Regardless of the exact implementation, such settlement methods are considered to be within the scope of the present invention.

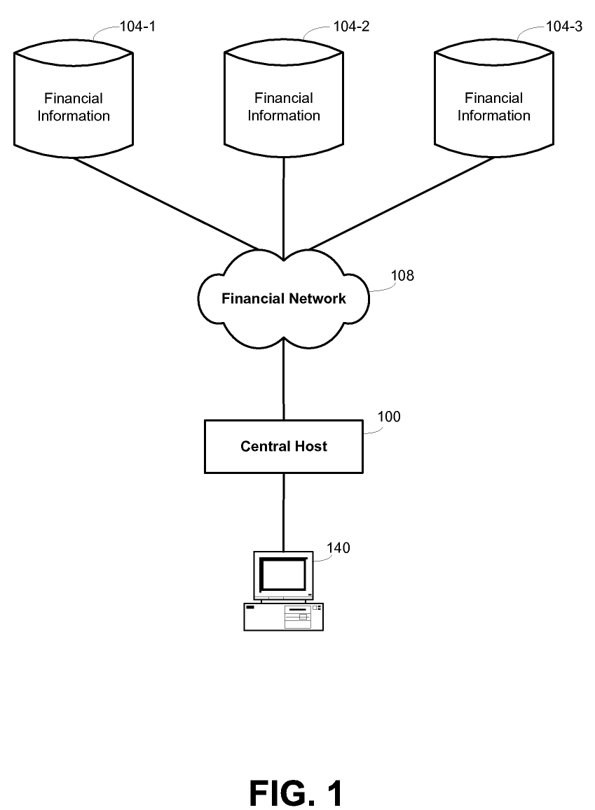

FIG. 1 is a block diagram illustrating an exemplary environment in which embodiments of the present invention may be implemented. This example illustrates a portion of an architecture into which a central host 100 can be configured to implement the methods disclosed herein. The central host may be any of a variety of general purpose personal computers including, merely by way of example, personal computers and/or laptop computers running various versions of Microsoft Corp.'s Windows, Apple Corp.'s Macintosh operating systems, any of a variety of commercially-available UNIX or UNIX-like operating systems (including without limitation, the variety of GNU/Linux operating systems), etc.

The data and/or rules received by the central host 100 may originate with one or more repositories of financial information 104 and be transmitted to the central host 100 through a financial network 108. The network may can be any type of network familiar to those skilled in the art that can support data communications using any of a variety of commercially-available protocols, including without limitation TCP/IP, SNA, IPX, AppleTalk, and the like. Merely by way of example, the network 108 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks.

The repositories of financial information 104 may comprise information collected from or on behalf of such entities as banks, credit unions, trust-management companies, mutual fund companies, discount brokerage firms, and the like. Additionally or alternatively, the repositories of financial information may include information provided by merchants related to various transactions. For example, such information may include information from or related to checks submitted to the merchants for payment of a transaction. By permitting communication with the repositories of financial information 104 through the financial network 108, the central host 100 may perform functions on behalf of a plurality of financial entities or may perform functions that report on information from multiple repositories of financial information 104 via one or more terminals 140. The terminals 140 may be any of a variety of possible types of devices including thin clients, personal computers, etc.

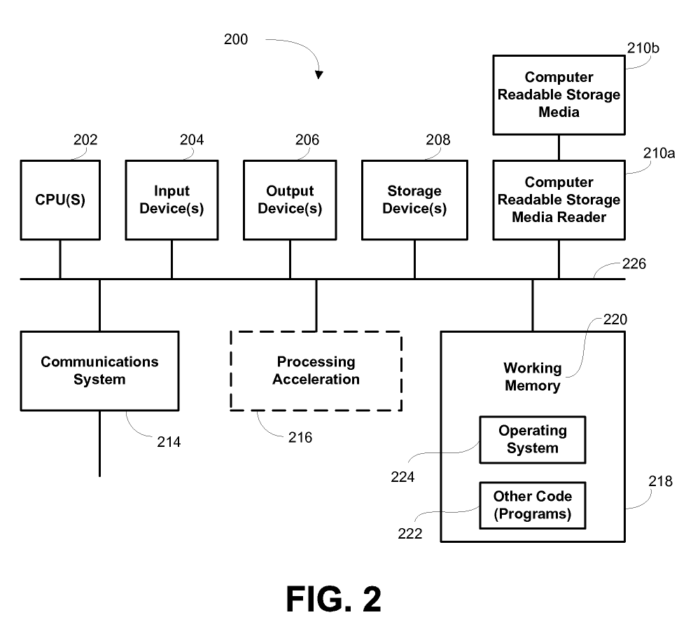

FIG. 2 is a block diagram illustrating an exemplary computer system upon which embodiments of the present invention may be implemented. The computer system 200 is shown comprising hardware elements that may be electrically coupled via a bus 255. The hardware elements may include one or more central processing units (CPUs) 205; one or more input devices 210 (e.g., a scan device, a mouse, a keyboard, etc.); and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above. In some embodiments, the computer system 2000 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with a network and/or any other computer or other type of device.

The computer system 200 may also comprise software elements, shown as being currently located within a working memory 240, including an operating system 245 and/or other code 250, such as an application program. The application programs may implement components of a the system and/or the methods of the invention as described herein. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

According to one embodiment, software of the computer system 200 can perform functions to support back office conversions of paper checks received at a point-of-sale and/or processing of check images provided by a point-of-sale device so equipped. For example, the software can support the processing of paper check items from a merchants location either through the ACH Network, paper drafts or by image exchange. Transactions can be sent to the bank, for example, as a NACHA formatted file or an X9.37 file.

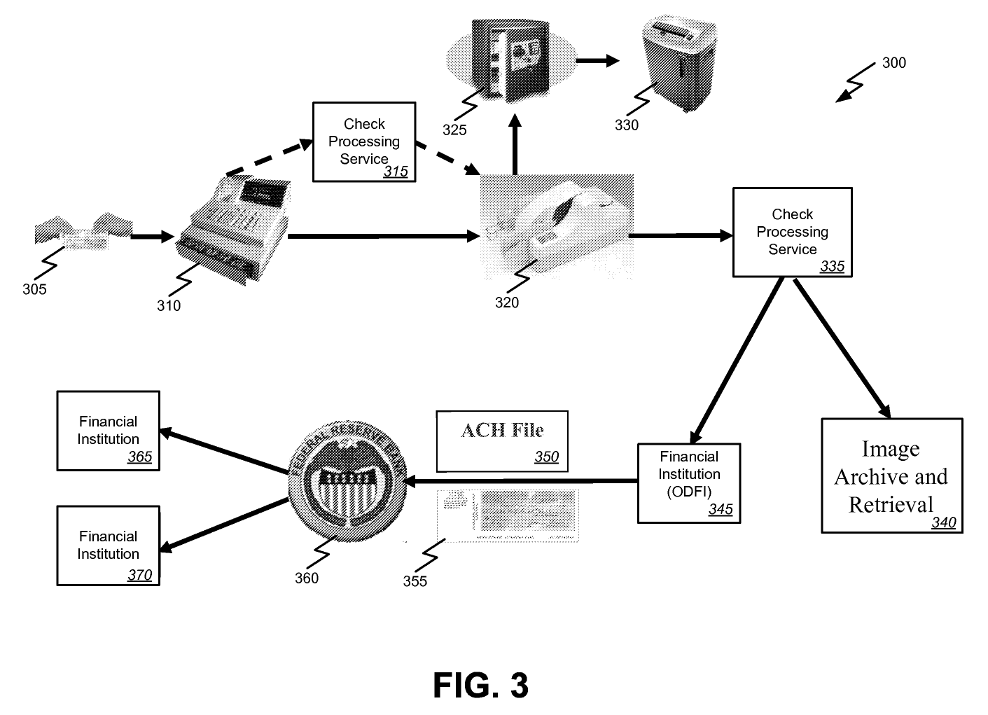

As noted above, embodiments of the present invention can provide various functions related to the submitted paper check. For example, processing can include, but is not limited to, providing an authorization and settlement process. FIG. 3 illustrates an authorization and settlement process 300 according to one embodiment of the present invention. In this example, a paper check 305 can be received at a check processing device such as point-of-sale device 310. The point-of-sale device 310 or other check processing device can be adapted to receive information from the check, for example via the MICR information encoded thereon, and request authorization of the transaction based on information from the check. Authorization may also be based on other information collected at or by the point-of-sale device 310. For example, such information can include but is not limited to a driver's license number, a phone number, or other identifying information for a party presenting the check. In some cases, the point-of-sale device 310 can be adapted to scan or otherwise image the check. The point-of-sale device 310 can be adapted to request authorization of the transaction from an authorization service such as check processing service 315. Upon receiving an indication of authorization from the check processing service 315 or other authorization service, a notification to the back office merchant system 320 can be generated and sent by the point-of-sale device 310. Also, a receipt can be printed that includes language indicating acceptance of the check.

At the end of the day, or at several times throughout the day, a merchant closes their register and takes the paper checks to the back office or other location. The checks can be submitted to the back office merchant system 320 through a terminal that scans the MICR and images the front and back of the check. In other cases, when the point-of-sale device 310 is so equipped, image data obtained at the point-of-sale device 310, for example by scanning or otherwise imaging the check, can be provided to the merchant system 320. Once scanned or image data is received, the paper checks can be stored 325 for some period and, after such period, destroyed 330. The merchant can utilize a software package of the merchant system 320 that reconciles transactions, allows for item correction, and performs file creation/submission. That is, the scanned and or imaged checks can be submitted to the software package of the merchant system 320 and matched to point-of-sale transactions for authorization by a check processing service 335, reconciliation of transactions at the point-of-sale 310, etc.

The images and other files submitted to the check processing service 335 can be sent to the Originating Depository Financial Institution (ODFI) 345 where the submitted files can be archived 340 and possibly made available to the merchant via a web interface. Additionally or alternatively, other entities such as the other financial institutions 365 and 370 and the check processing service 335 can make the images available to the merchant. The ODFI 345 can create ACH 350 and/or Image Exchange 355 records and process the settlement. For example, the ODFI 345 can send the ACH transaction to the Federal Reserve 360. The Federal Reserve bank 360, upon receipt of the ACH transaction, can in turn instruct the receiving banks 365 and 370 to complete the transaction and fund the merchant.

Stated another way, the point-of-sale device 310 can be adapted to receive information from the check 305, request authorization of the transaction based on information from the check and possibly other information, and, in response to the transaction being authorized, provide a notification of the transaction to the merchant system 320. For example, the point-of-sale device 310 can be adapted to request authorization of the transaction from a check processing service 315. The merchant system 320 can be adapted to receive the notification of the transaction from the point-of-sale device 310, receive image data representing an image of the check, for example by later scanning or otherwise imaging the check or by receiving the image data from the point-of-sale device, and perform a reconciliation process based on the notification and the image data. Settlement of the transaction can be performed by a single settlement process or a split-settlement process as will be described below.

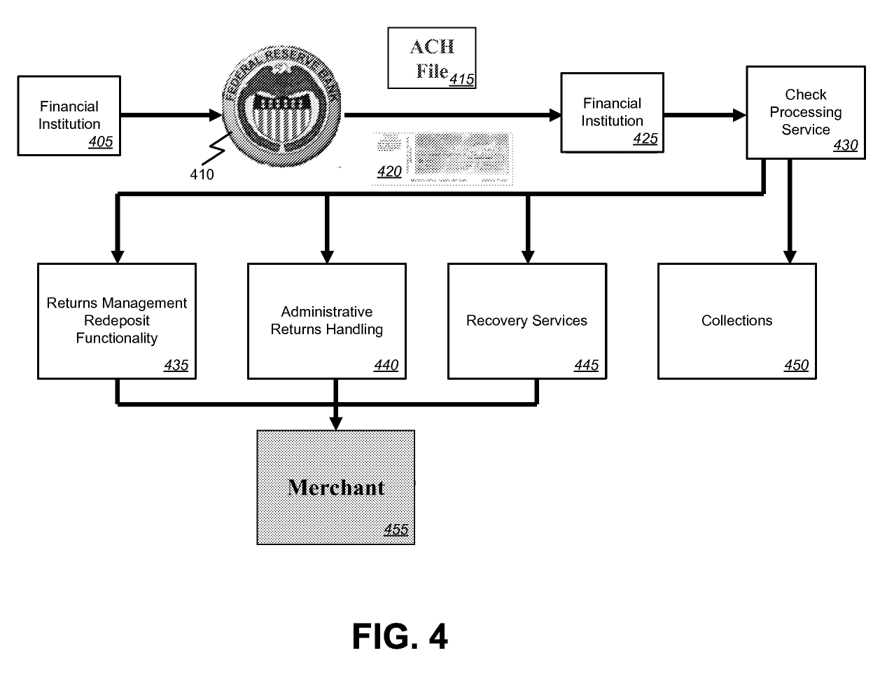

FIG. 4 illustrates a returns management process according to one embodiment of the present invention. In this example, ACH files 415 and/or IRD files 420 for items returned from a Receiving Depository Financial Institution (RDFI) 405 or paying bank can be sent back to the merchant's financial institution 425 by the Federal Reserve Bank 410. Returned items can then be handled in any of a variety of ways. Generally speaking, returned items can be collected directly by the merchant 455 or sent to a check processing service 430 for collection. The check processing service 430, in addition to providing collection services 450 can also provide returns management redeposit functionality 435, administrative returns handling 440, and recovery services 445 to the merchant as known in the art.

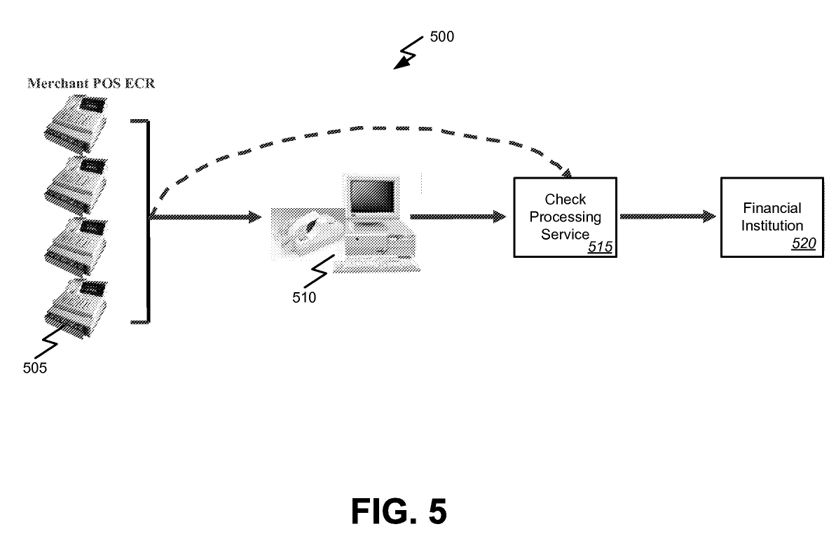

According to one embodiment, different processing models can be provided for settling transaction. These models can include a single settlement process and a split settlement process. FIG. 5 illustrates a single settlement process according to one embodiment of the present invention. Under single settlement the merchant can authorize a transaction at the point-of-sale 505, for example by requesting authorization by a check processing service 515, and puts all of their paper items in their cash register drawer. The point-of-sale device can, in some cases, also scan or otherwise image the check. Additionally or alternatively, the merchant can scan their paper items through a certified hardware/software package of the merchant system 510. In either case, the merchant system 510 and send the image files to a check processing service 515 for processing. A path of settlement, i.e., one or more financial institutions 520 for settlement, can be determined by the check processing service 515 and the merchant can receive a combined, single settlement. Stated another way, single settlement provides a back office model where the merchant authorizes through a check processing service at the point-of-sale and puts all of their paper items in their cash register drawer. In the back office, at the point-of-sale, or at other location, the merchant scans the paper items through a hardware/software package and sends the aggregated files for processing. In some cases, the merchant can key enter MICR information for authorization, when the items are processed in the back office. In other cases, the MICR can be machine-read by the merchant system 510 which allows for ACH processing of the item.

The check processing service 515 can match the items in the file to the authorized items from the point-of-sale 505 and make a transaction decision on how to best settle the item, either as an ACH or image exchange or other settlement method depending, for example, on a least cost routing. If the check processing service 515 does not receive an image for an item approved at the point-of-sale 505 in this model, the service may not settle the item through the ACH (as this may be a violation of the NACHA Operating Rules) or as a Check 21 item (since this process uses image data of the check to settle). The settlement to the merchant can include both ACH and Check 21 items aggregated for one settlement to the merchant.

According to one embodiment, if an item is received by the check processing service 515 through an image file and the check processing service 515 declined the item at the point-of-sale 505, a record can be displayed in an exception section of the merchants periodic Funding Report provided by the check processing service 515 as a “Transaction Declined”. In such cases the image can be maintained for information purposes. If an item is received through the image file and the check processing service 515 cannot match it to an authorized item received at the point-of-sale 505, the record can be displayed in an Exception Section of the merchants Funding Report as “No Matching Transaction”. Again the image can be maintained for information purposes. Matching of transactions and items by the check processing service 515 can be based on raw MICR data, check number, check amount, store number, or other criteria.

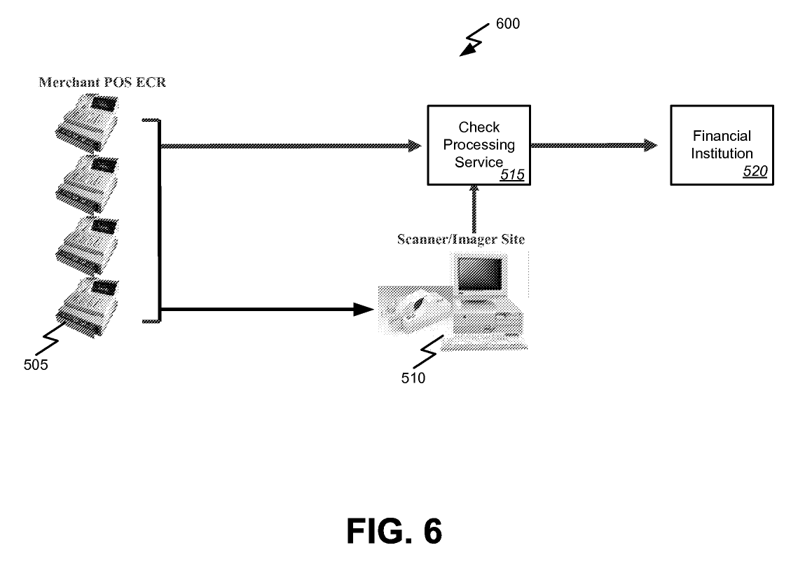

FIG. 6 illustrates a split settlement process according to one embodiment of the present invention. Under split settlement, items can be approved at the point-of-sale 505 by the check processing service 515 and identified by the check processing service 515 as “ACH'able”, i.e., able to be processed through the ACH Network by the check processing service 515. Items not approved as ACH'able can wait to be processed as Check 21 items when the image is received by the check processing service 515 from the merchant system 510. In this model, the ACH items may settle to the merchants account prior to the Check 21 items processed at the point-of-sale on the same day as the ACH items.

More specifically, under split settlement, items can be approved at the point-of-sale 505 as ACH'able and processed through the ACH Network by the check processing service 515 for settlement with one or more financial institutions 520. Items not approved as ACH'able can wait to be processed as Check 21 items when the image is received by the check processing service 515 from the merchant system 510. As noted, the ACH items may settle to the merchants account prior to the Check 21 items processed at the point-of-sale on the same day as the ACH items. However, Check 21 items may be included in the aggregated merchant settlement that where processed at the point-of-sale on previous days but the service processed the image file received from the merchant on that processing day. For example: Monday, merchant processes 100 items at the point-of-sale, 95 ACH and 5 Check 21. On Tuesday, the service processes the 95 items in the ACH file for settlement on Wednesday. Tuesday, the merchant processes 120 items at the point-of-sale, 100 ACH and 20 Check 21. On Wednesday, the service processes the 100 ACH items for settlement on Thursday. On Tuesday night, the merchant sends up all the images from point-of-sale transactions processed on Monday and Tuesday. In Wednesday's processing, the service also process the 25 Check 21 items and combines the settlement to the merchant with the 100 ACH items processed on Wednesday.

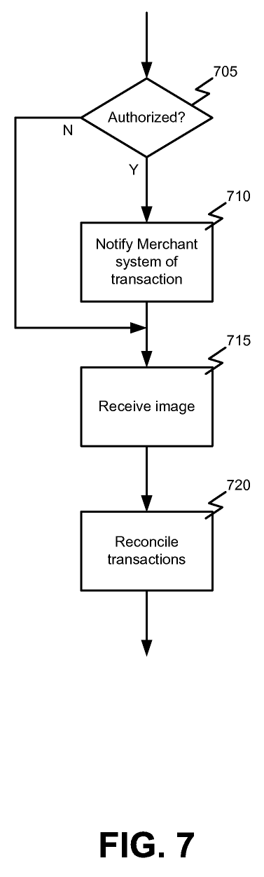

FIG. 7 is a flowchart illustrating a process for handling a check submitted in a transaction according to one embodiment of the present invention. In this example, the process begins with authorizing 705 the transaction at a point-of-sale device based on information from the check. Authorizing 705 the transaction can comprise requesting authorization of the transaction by a check processing service from the point-of-sale device. In response to authorizing 705 the transaction, a notification 710 of the transaction can be provided from the point-of-sale device to the merchant system. Image data representing an image of the check can also be received 715 at the merchant system, for example from a scan of the check at the point-of-sale device, at the merchant system, or via another system. A reconciliation 720 can be performed based on the notification and the image data.

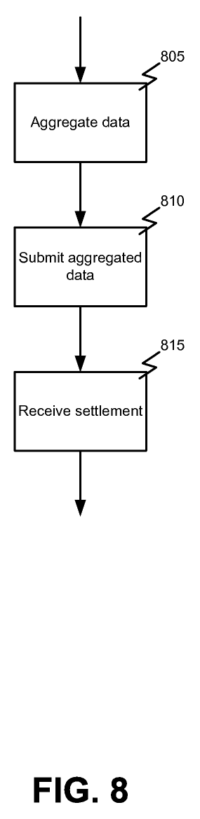

FIG. 8 is a flowchart illustrating a process for single settlement according to one embodiment of the present invention. In this example, the process begins with aggregating 805 data of a plurality of checks. The plurality of checks can comprise checks to be settled via an Automated Clearinghouse (ACH) process and checks to be settled via a Check 21 process. The aggregated data can be submitted 810 to a check processing service for settlement and a single settlement for the plurality of checks can be received 815 from the check processing service.

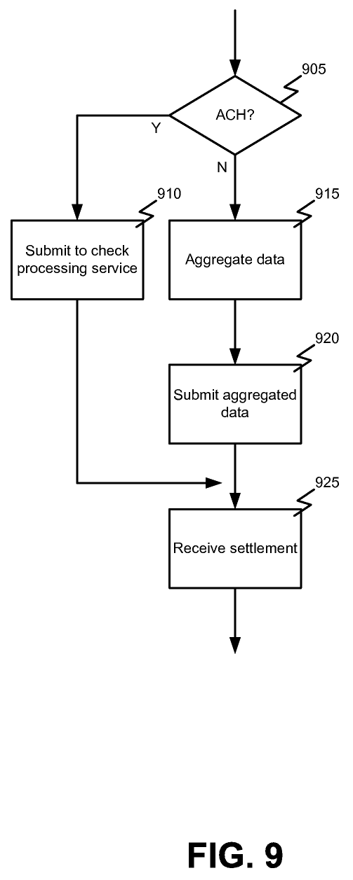

FIG. 9 is a flowchart illustrating a process for split settlement according to one embodiment of the present invention. In this example, the process begins with determining 905, for example by the check processing service, whether the check can be submitted for settlement via an Automated Clearinghouse (ACH) process. In response to determining 905 the check can be submitted 910 for settlement via the ACH process, the check data can be submitted 910 to the check processing service for settlement via an ACH network. In response to determining 905 the check cannot be submitted for settlement via an ACH process, data of a plurality of checks can be aggregated 915 and submitted 920 to the check processing service for settlement via a Check 21 process. A single settlement for the aggregated plurality of checks can be received 925 from the check processing service.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of handling a check submitted in a transaction, the method comprising:
requesting authorization of the transaction by an authorization service from a check processing device;
in response to the authorization service authorizing the transaction, receiving a notification of the transaction from the check processing device;
receiving image data representing an image of the check; and
performing a reconciliation process based on the notification and the image data.

2. The method of claim 1, further comprising performing a single settlement process.

3. The method of claim 2, wherein the single settlement process comprises:
aggregating data of a plurality of checks, wherein the plurality of checks comprises checks to be settled via an Automated Clearinghouse (ACH) process and checks to be settled via a Check 21 process;
submitting the aggregated data to the authorization service for settlement; and
receiving from the authorization service a single settlement for the plurality of checks.

4. The method of claim 1, further comprising performing a split settlement process.

5. The method of claim 4, wherein the split settlement process comprises determining whether the check can be submitted for settlement via an Automated Clearinghouse (ACH) process.

6. The method of claim 5, further comprising, in response to determining the check can be submitted for settlement via the ACH process, submitting the check data to the authorization service for settlement via an ACH network.

7. The method of claim 5, further comprising, in response to determining the check cannot be submitted for settlement via an ACH process, aggregating data of a plurality of checks, submitting the aggregated data to the authorization service for settlement via a Check 21 process, and receiving from the authorization service a single settlement for the plurality of checks.

8. A system for handling a check submitted in a transaction, the system comprising:
a check processing device adapted to receive information from the check, request authorization of the transaction from an authorization service based on information from the check, and, in response to the authorization service authorizing the transaction, provide a notification of the transaction; and
a merchant system communicatively coupled with the check processing device, the merchant system adapted to receiving the notification of the transaction from the check processing device, receive image data representing an image of the check, and perform a reconciliation process based on the notification and the image data.

9. The system of claim 8, wherein the merchant system is further adapted to perform a single settlement process.

10. The system of claim 8, wherein the single settlement process comprises:
aggregating data of a plurality of checks, wherein the plurality of checks comprises checks to be settled via an Automated Clearinghouse (ACH) process and checks to be settled via a Check 21 process;
submitting the aggregated data to the authorization service for settlement; and
receiving from the authorization service a single settlement for the plurality of checks.

11. The system of claim 8, wherein the merchant system is further adapted to perform a split settlement process.

12. The system of claim 11, wherein the authorization service is adapted to determine whether the check can be submitted for settlement via an Automated Clearinghouse (ACH) process.

13. The system of claim 12, wherein the authorization service is further adapted to, in response to determining the check can be submitted for settlement via the ACH process, submit the check data for settlement via an ACH network.

14. The system of claim 12, wherein the merchant system is further adapted to, in response to the authorization service determining the check cannot be submitted for settlement via an ACH process, aggregate data of a plurality of checks, submit the aggregated data to the authorization service for settlement via a Check 21 process, and receive from the authorization service a single settlement for the plurality of checks.

15. A machine-readable medium having stored thereon a series of instructions which, when executed by a processor, cause the processor to handle a check submitted in a transaction by:
requesting authorization of the transaction by an authorization service from a check processing device;
in response to the authorization service authorizing the transaction, receiving a notification of the transaction from the check processing device;
receiving image data representing an image of the check; and
performing a reconciliation process based on the notification and the image data.

16. The machine-readable medium of claim 15, further comprising performing a single settlement process.

17. The machine-readable medium of claim 16, wherein the single settlement process comprises:
aggregating data of a plurality of checks, wherein the plurality of checks comprises checks to be settled via an Automated Clearinghouse (ACH) process and checks to be settled via a Check 21 process;
submitting the aggregated data to the authorization service for settlement; and
receiving from the authorization service a single settlement for the plurality of checks.

18. The machine-readable medium of claim 15, further comprising performing a split settlement process.

19. The machine-readable medium of claim 18, wherein the split settlement process comprises determining whether the check can be submitted for settlement via an Automated Clearinghouse (ACH) process.

20. The machine-readable medium of claim 19, further comprising, in response to determining the check can be submitted for settlement via the ACH process, submitting the check data to the authorization service for settlement via an ACH network.

21. The machine-readable medium of claim 19, further comprising, in response to determining the check cannot be submitted for settlement via an ACH process, aggregating data of a plurality of checks, submitting the aggregated data to the authorization service for settlement via a Check 21 process, and receiving from the authorization service a single settlement for the plurality of checks.
